(19) United States
(12) Patent Application Publication
(10) Pub. No.: US 2010/0073219 A1
(43) Pub. Date: Mar. 25, 2010

(54) METHOD OF ELECTROMAGNETIC INTERFERENCE ASSESSMENT

(75) Inventor: QIN HE, Zhuhai Guamgdong (CN)

Correspondence Address: ROSENBERG, KLEIN & LEE, 3458 ELLICOTT CENTER DRIVE-SUITE 101, ELLICOTT CITY, MD, 21043, US

(73) Assignee: ALI (ZHUHAI) CORPORATION, ZHUHAI GUANGDONG (CN)

(21) Appl. No.: 12/334,786

(22) Filed: Dec. 15, 2008

(30) Foreign Application Priority Data
Sep. 24, 2008 (CN) 200810161512.0

(51) Int. Cl. G01S 7/40

(52) U.S. Cl. 342/173

(57) ABSTRACT

A method of electromagnetic interference assessment applicable to a receiver, comprising the following steps: initially, scanning a plurality of frequencies; next, for each scanned frequency, measuring corresponding signal strength value; finally, based on the correspondence between the frequencies and the signal strength values, acquiring an analysis curve graph, furthermore assessing the extent of electromagnetic interference occurring in the receiver through the acquired analysis curve graph.

### BACKGROUND OF THE INVENTION

1. Field of the Invention

The present invention relates to an assessment method; in particular, to a method of electromagnetic interference assessment.

2. Description of Related Art

Thanks to rapid and striding advancements in modern communication technologies and compression technologies, television broadcast around the world has now gradually evolved from analog television broadcast into digital television broadcast. The revolution of digital broadcast led to dramatic development of relevant industries, in which digital TV sets and Set Top Box (STB) are just a few of the examples.

Present digital media services are mostly provided by program producers or telecast companies that broadcast digital radio frequency (RF) signals from the transmitter antenna, and users may employ a digital TV set, a STB, or other digital reception system supporting the utilized broadcast standards to receive the digital RF signals for various further digital processes, then rendering the transmitted TV programs or audio/video (AV) multimedia information. Because of the aforementioned devices all use built-in receivers to receive signals, thus the performance in the receiver directly influence the quality of received signals.

In addition to possible distortion or interruption in the digital RF signals because of multi-path interference during transmission, poor design in the printed circuit board of the receiver may further result in reduced reception performance as well. Based on the pursuit of compact size, the components and layouts configured on the printed circuit board are becoming denser than ever; in case of inappropriate layout design, the printed circuit board may radiate undesirable electromagnetic interferences, thus causing signal deterioration problem at a specific frequency. Additionally, length and width of wires may also influence the resistance and inductance thereof, accordingly generating complicated electromagnetic effect that causes impact on frequency responses. Therefore, in order to receive the correct channel, the reception system of the receiver needs to perform tuning processes to verify if there is any possibility that electromagnetic interference may occur in later use.

However, commonly used methods at present days for said tuning processes need to perform electromagnetic radiation tests on the receiver in the electromagnetic conformity laboratory to locate the frequencies vulnerable to electromagnetic interference, and based on engineer's experience and knowledge to modify the configuration, and then repeatedly execute the electromagnetic interference tests until the reception function is qualified for specification. The aforementioned operations may consume a significant amount of time and expenses, and the complicated procedure in the strict tuning processes may limit the development of receiver as well.

### SUMMARY OF THE INVENTION

Regarding the issues which described heretofore, the present invention provides a method of electromagnetic interference assessment, which, under the circumstances of a receiver not being connected to a reception antenna, records the signal strength values of multiple frequencies in the entire frequency reception range, and assesses which frequencies are influenced by electromagnetic interference based on the acquired signal strength values, so as to effectively observe the extent of influence caused by electromagnetic interference, furthermore enabling configuration modification to eliminate radiation sources.

Therefore, the objective of the present invention is to provide a method of electromagnetic interference assessment that facilitates effective and efficient assessment on the extent of influence caused by electromagnetic interference.

Another objective of the present invention is to provide a method of electromagnetic interference assessment that facilitates cost reduction of assessment for electromagnetic interference of the receiver.

The present invention discloses a method of electromagnetic interference assessment applicable to a receiver. The method comprises the following steps: initially, scanning a plurality of frequencies; next, for each scanned frequency, measuring corresponding signal strength value; finally, based on the correspondence between the frequencies and the signal strength values, acquiring an analysis curve graph, furthermore assessing the extent of electromagnetic interference of the receiver through the acquired analysis curve graph.

In one embodiment of the present invention, the step of scanning a plurality of frequencies consists of first setting a frequency reception range, then sequentially receiving from the lowest frequency of the frequency reception range to the highest frequency thereof, while the frequency intended to be received being step-wise increased in order to measure the corresponding signal strength value.

In one embodiment of the present invention, the method further comprises the following steps: providing at least one preferred curve graph; then comparing the analysis curve graph with the preferred curve graph; and determining whether or not any electromagnetic interference occurs in the receiver based on the comparison.

Through the aforementioned technical solution, the present invention can be used to record the signal strength value of each reception frequency, and generates information for determining the reception performance of the receiver, further facilitating users to precisely and quickly assess the electromagnetic interference condition of the receiver with lower cost.

The aforementioned summary and following detailed descriptions and appended drawings are all intended to further illustrate the approaches, means, and effects taken by the present invention to achieve the prescribed objectives. Other purposes and advantages related to the present invention will be thoroughly construed in the descriptions and diagrams set forth infra.

### BRIEF DESCRIPTION OF THE DRAWINGS

FIG. 1 shows a system architecture schematic diagram for an embodiment of the receiver according to the present invention;

FIG. 2 shows a schematic diagram for an embodiment of the assessment interface according to the present invention;

FIG. 3 shows a schematic diagram for another embodiment of the assessment interface according to the present invention;

FIG. 4 shows a schematic diagram for yet another embodiment of the assessment interface according to the present invention;

FIG. 5 shows a diagram for an embodiment of the analysis curve graph according to the present invention;

FIG. 6 shows a diagram for another embodiment of the analysis curve graph according to the present invention; and

FIG. 7 shows a step-wise flowchart for the method of electromagnetic interference assessment according to the present invention.

### DETAILED DESCRIPTION OF PREFERRED EMBODIMENTS

The present invention discloses a method of electromagnetic interference assessment, which, under the circumstances of a receiver not being connected to a reception antenna, scans the frequencies in the entire operating frequency range and records the signal strength value of each frequency, further assessing which frequencies are influenced by electromagnetic interference based on the acquired signal strength values, so as to efficiently assess the extent of influence caused by electromagnetic interference of the receiver, enabling advantages of cost reduction and time saving as well.

The major technical characteristic of the present invention are in that, to automatically scan each frequency in the operating frequency range of the receiver, and to record the information of signal strength values thereof for assessing the reception performance in the receiver. Hereunder only the required hardware architecture and operations thereof are illustrated; however, those skilled in the art can appreciate that, in addition to the elements set forth below, other components in the receiver may also be involved; thus it is by no means to be limited to what are disclosed herein.

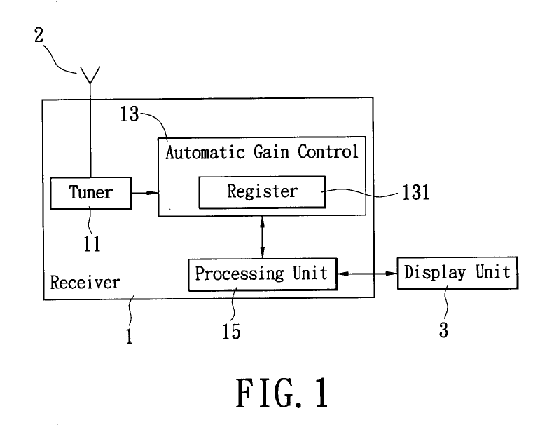

Initially, refer to FIG. 1, wherein a system architecture schematic diagram for an embodiment of the receiver according to the present invention is shown. As illustrated in FIG. 1, the receiver 1 receives radio frequency (RF) signals indicating the digital media frequency radiated from a transmitter via an externally connected antenna 2, and then by using a display unit 3 to render TV programs or audio/video multimedia. In practical implementations, the receiver 1 can be a digital TV set, a Set Top Box (STB), or other digital reception system supporting broadcast standards, and each receiver 1 has its own specific operating frequency range; i.e. it can only receive digital information transmitted through each channel located in the operating frequency range. The receiver 1 comprises at least one tuner 11, an automatic gain control 13, and a processing unit 15. The tuner 11 may also select specific RF signals (channel or program), filtering out undesirable RF signals to prevent possible interference on the intended channel caused by such undesirable RF signals during frequency reduction process. The automatic gain control 13 is coupled to the tuner 11, used to perform appropriate amplification or suppression on the RF signal processed by the tuner 11, thus assuring normal operations done in the back-end digital processing unit. The automatic gain control 13 is installed with a register 131 for storing a signal strength value of the currently received RF signal. The processing unit 15 is coupled between the automatic gain control 13 and the display unit 3 for controlling the operations of components in the receiver 1, so as to transfer the multimedia information generated after the above-said processes on the RF signals to the display unit 3.

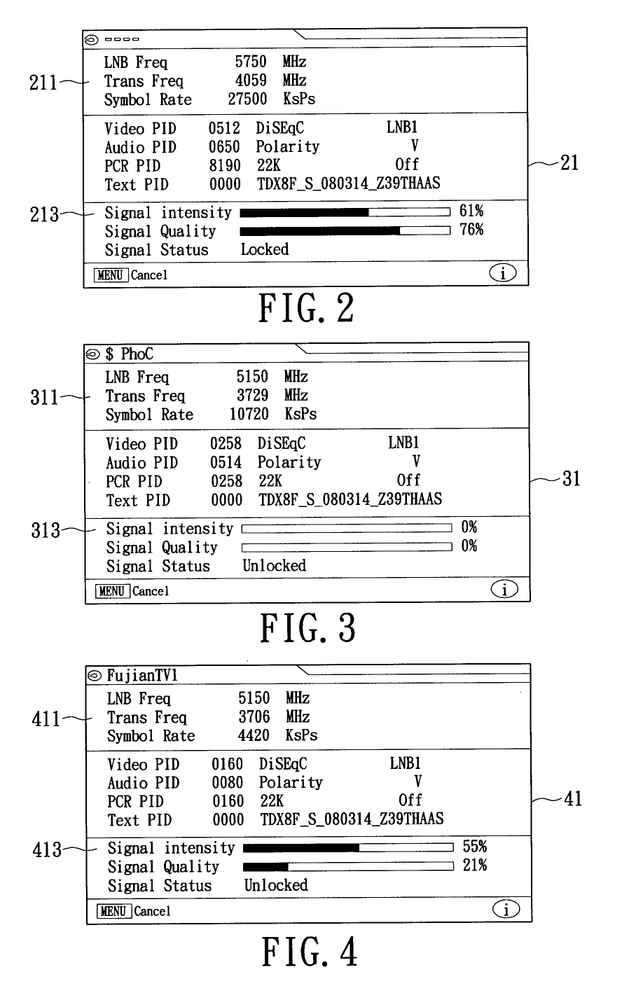

The method of electromagnetic interference assessment according to the present invention is to provide an electromagnetic interference assessment program, which, when executed, enables the display unit 3 to render the currently received frequency (i.e. the RF signal) and acquires the signal strength value of the frequency from the register 131 in the automatic gain control 13. Refer now to FIG. 2, wherein a schematic diagram for an embodiment of the assessment interface according to the present invention is shown. As shown in FIG. 2, the display unit 3 generates an assessment interface 21 which shows that the currently scanned frequency 211 is 4059 MHz, whose signal strength value 213 is 61%, thereby the signal strength or signal quality of the currently scanned channel may be visualized.

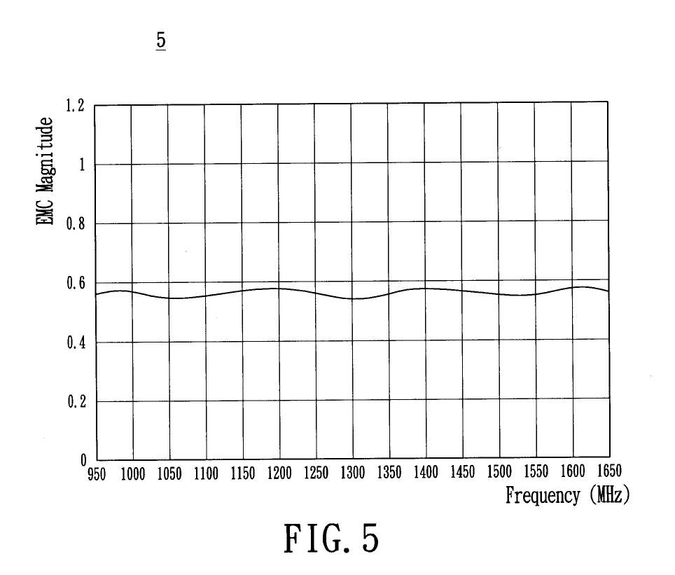

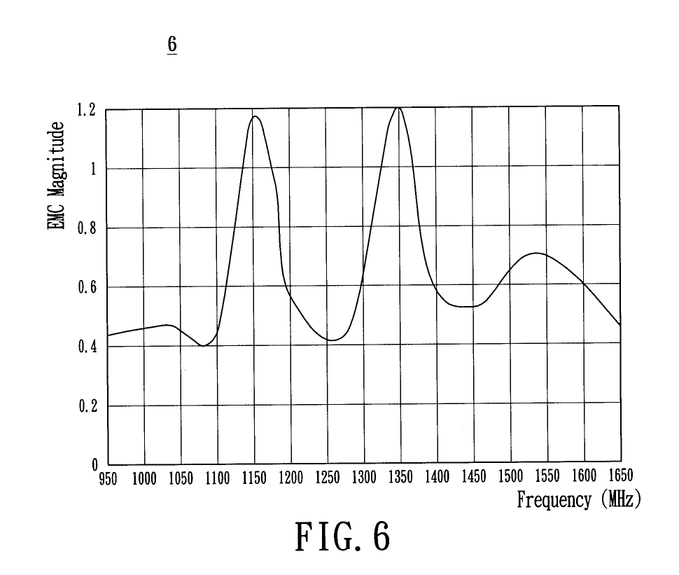

To identify the extent of electromagnetic interference occurred in each of the received frequency, the method according to the present invention is essentially used under a circumstance when the receiver 1 being unplugged/unconnected from the antenna 2. If the antenna 2 is not connected, then the signal strength of the tested frequency from the receiver 1 which has good performance and is free from electromagnetic interference should have a signal strength value to be zero or a rather small value; however suppose a certain signal strength at some frequency can still be detected, then it can be determined that the frequency is subjected to the electromagnetic interference from the motherboard in the receiver 1. Refer in conjunction to FIGS. 3 and 4, wherein schematic diagrams for another embodiment of the assessment interface according to the present invention are shown. As depicted in FIG. 3, after the execution of electromagnetic interference assessment procedure by a user, the assessment interface 31 generated by the display unit 3 reveals that the currently scanned frequency 311 is 3729 MHz, whose signal strength 313 is 0%, thus indicating the extent of electromagnetic interference in the assessed frequency is comparatively small. Contrarily, as shown in FIG. 4, the assessment interface 41 shows that the currently received frequency 411 is 3706 MHz, whose signal strength 413 contains a non-zero value, thus indicating noise signal may be generated in the assessed frequency due to layout or wire resistance of the printed circuit board in the receiver 1, further leading to occurrence of electromagnetic interference. Through the aforementioned approaches, the user may set a frequency reception range in the receiver 1; actually, the frequency reception range can be the operating reception range of the receiver 1, in which the processing unit 15 of the receiver 1 continuously sends instructions to the tuner 11 to perform frequency scans, allowing the tuner 11 to lock on each frequency within the frequency reception range, further enabling the electromagnetic interference assessment program to automatically start to sequentially scan from the lowest frequency in the frequency reception range to the highest frequency with a certain step-wise frequency increment, thereby scanning through each channel in the entire frequency reception range and recording the signal strength value thereof. In this way, the signal strength value at each operating frequency can be collected in order to generate analysis information allowing for the tester's references. Refer now to FIGS. 5 and 6, wherein diagrams of an embodiment for the analysis curve graph according to the present invention are shown. After completion of frequency scan by the electromagnetic interference assessment procedure, an analysis curve graph 5 will be generated based on the correspondence between the received frequency and the signal strength value thereof. As shown in FIG. 5, the abscissa on the graph is the frequency, the ordinate indicates the signal strength value, and small corresponding signal strength value of each frequency represents good performance in the receiver 1, which indicates less possibility of occurrence of electromagnetic interference. Contrarily, the analysis curve graph 6 shown in FIG. 6 reveals greater signal strength values at frequencies 1150 MHz and 1350 MHz, thus indicating occurrence of electromagnetic interference at such frequencies. Accordingly, the user may perform necessary modification and adjustment on wiring of the receiver 1 based on the assessment results, repeat the frequency scan procedure as above, until an analysis curve graph approximate to what a receiver 1 of good performance, low extent of electromagnetic interference may demonstrate is finally acquired.

In an embodiment of the present invention, other than determining performance of receiver 1 by manual observation on the analysis curve graph, it is also possible to store at least one preferred curve graph in the receiver 1 for reference, in which the processing unit 15 compares the measured analysis curve graph with the prescribed preferred curve graph; if the difference between these two curve exceeds a tolerable range, then the receiver 1 is determined to present occurrence of electromagnetic interference.

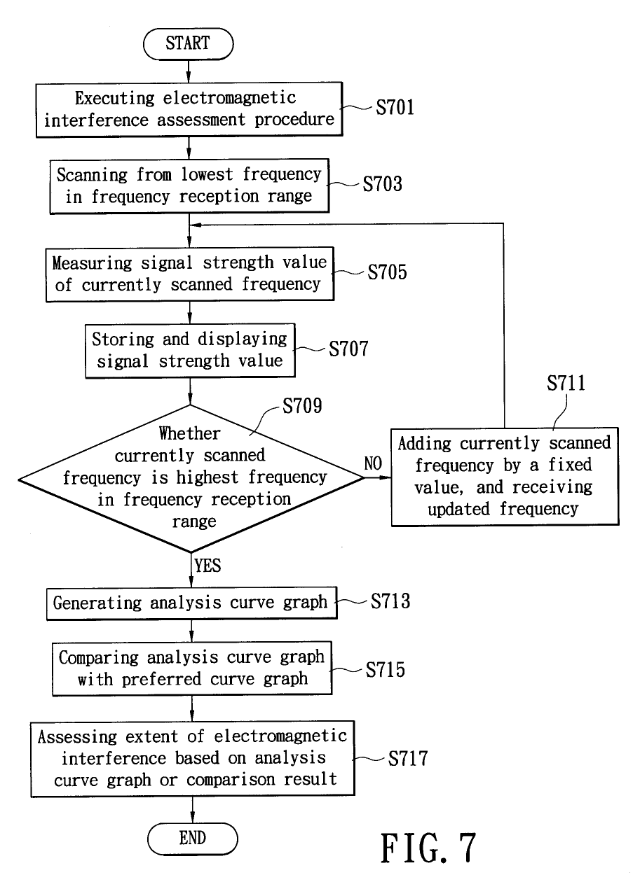

Finally, refer now to FIG. 7, wherein a step-wise flowchart for the method of electromagnetic interference assessment according to the present invention is shown. FIGS. 1 to 6 are also conjunctively referred for relevant system and process patterns. As depicted in FIG. 7, the said method of electromagnetic interference assessment comprises the following steps:

Initially, a user inputs instructions through a remote control or enters a specific key combination into the receiver 1 to start the electromagnetic interference assessment procedure (step S701); the receiver 1 then scans the channels in the entire frequency reception range, which begins with the lowest frequency (step S703); subsequently, the automatic gain control 13 measures the signal strength value at the currently scanned frequency (step S705); and the processing unit 15 stores the signal strength value recorded in the register 131 and renders it on the display unit 3 (as shown by the assessment interface 21) (step S707);

afterward, the processing unit 15 determines whether or not the currently scanned frequency is the highest one in the frequency reception range (step S709); if not, then add the currently received frequency by a certain fixed increment and receives the updated frequency, continuing the operation downward from step S705, until all signal strength values corresponding to the frequencies in the entire frequency reception range are measured (step S711); if the determination in step S709 is yes, then it indicates that all frequencies in the frequency reception range have been scanned through once, and an analysis curve graph is generated based the correspondence between the frequency and the signal strength value thereof (step S713), facilitating the user to observe the electromagnetic interference condition of the receiver 1 at each frequency;

Finally, the processing unit 15 compares the generated analysis curve graph with the prescribed preferred curve graph (step S715), further allowing the user to assess the extent of electromagnetic interference therein selectively based on the analysis curve graph or the comparison results (step S717).

Through the method described supra, the user is able to be aware of which frequencies are undesirably influenced by electromagnetic interference to perform adequate amendments, such as correcting wiring on the printed circuit board or modifying component layout pattern in the receiver . . . etc., and then after completion of such amendments, repeats the method provided by the present invention to perform tests on the receiver, until the test results are qualified.

In accordance with the aforementioned detailed descriptions of embodiments, it can be seen that the method of electromagnetic interference assessment of the present invention scans entire frequency reception range of the receiver, and records signal strength value of each received frequency, further assessing which frequencies are influenced by electromagnetic interference based on the correspondence between frequency and signal strength value. Thereby, it is convenient to observe the electromagnetic interference condition of the receiver, and to appreciate the Electro Magnetic Compatibility (EMC) of the receiver from the extent of electromagnetic interference, accordingly providing improvements on the drawbacks of expensive cost and operation time required for conventional receiver tests.

The aforementioned disclosure simply sets forth the detailed descriptions and appended drawings for the embodiments of the present invention, rather than being used to limit the present invention. The scope of the present invention should be based on the following claims; all changes and modifications that those skilled in the art may conveniently consider in the fields of the present invention are reasonably deemed to be encompassed within the scope of the present invention delineated by the claims disclosed hereunder.

What is claimed is:

1. A method of electromagnetic interference assessment, characterized in that it is applicable under a condition in which a receiver is not connected to an antenna to receive at least one digital radio frequency signal, the assessment method comprises the following steps:
scanning a plurality of frequencies;
measuring corresponding signal strength value for each of the frequencies;
assessing the extent of electromagnetic interference of the receiver based on the measured signal strength values.

2. The method of electromagnetic interference assessment according to claim 1, characterized in that, before the step of scanning the frequencies, it further comprises the following steps:
providing an electromagnetic interference assessment procedure in the receiver; and
executing the electromagnetic interference assessment procedure to assess the extent of electromagnetic interference of the receiver at each frequency.

3. The method of electromagnetic interference assessment according to claim 1, characterized in that, in the step of scanning the frequencies, it comprises the following steps:
setting a frequency reception range; and
sequentially scanning from the lowest frequency in the frequency reception range to the highest frequency therein.

4. The method of electromagnetic interference assessment according to claim 3, characterized in that, in the step of measuring the signal strength values, the signal strength value of a frequency is measured each time the frequency is scanned, until all corresponding signal strength values of the frequencies in the frequency reception range are measured.

5. The method of electromagnetic interference assessment according to claim 4, characterized in that, in the step of assessing the extent of electromagnetic interference based on the signal strength values, it comprises the following steps:
recording the signal strength values; and
acquiring an analysis curve graph based on the correspondence between the frequencies and the signal strength values.

6. The method of electromagnetic interference assessment according to claim 5, characterized in that, in the step of assessing the extent of electromagnetic interference based on the signal strength values, it further comprises the following steps:
the closer the signal strength value approaches to zero, the smaller the extent of electromagnetic interference at the corresponding frequency of the signal strength value is; and
otherwise, the greater the extent of electromagnetic interference at the corresponding frequency of the signal strength value is.

7. The method of electromagnetic interference assessment according to claim 5, characterized in that, in the step of assessing the extent of electromagnetic interference based on the signal strength values, it further consists of the following steps:
providing at least one preferred curve graph;
comparing the analysis curve graph with the preferred curve graph; and
determining whether or not electromagnetic interference of the receiver occurs based on the comparison result.

8. The method of electromagnetic interference assessment according to claim 7, characterized in that it further consists of the following steps:
displaying the signal strength values; and
displaying the analysis curve graph.

9. The method of electromagnetic interference assessment according to claim 1, characterized in that the receiver is a Set Top Box (STB).

10. The method of electromagnetic interference assessment according to claim 1, characterized in that it uses an automatic gain control to detect the corresponding signal strength value of each frequency.

11. The method of electromagnetic interference assessment according to claim 3, characterized in that the frequencies are respectively measured for the corresponding signal strength value thereof is of step-wise increment.
